(19) United States
(12) Patent Application Publication
(10) Pub. No.: US 2023/0259868 A1
(43) Pub. Date: Aug. 17, 2023

(54) DELIVERY MANAGEMENT SYSTEM, DELIVERY MANAGEMENT METHOD, AND RECORDING MEDIUM

(71) Applicant: NEC Corporation, Minato-ku, Tokyo (JP)

(72) Inventors: Shunsuke TSUDA, Tokyo (JP); Hajime HAGIMORI, Tokyo (JP)

(73) Assignee: NEC Corporation, Minato-ku, Tokyo (JP)

(21) Appl. No.: 18/014,964

(22) PCT Filed: May 25, 2021
(86) PCT No.: PCT/JP2021/019731

§ 371 Date: Jan. 6, 2023

(30) Foreign Application Priority Data
Jul. 9, 2020 (JP) 2020-118333

(51) Int. Cl. G06Q 10/0833; G06T 7/70; G06V 40/20; G06V 20/52

(52) U.S. Cl. CPC G06Q 10/0833; G06T 7/70; G06V 40/20; G06V 20/52; G06T 2207/30232

(57) ABSTRACT

A delivery management system according to an aspect of the present disclosure includes: at least one memory configured to store instructions, and at least one processor configured to execute the instructions to detect placement of a delivery item at a placement location, and generate a verification image obtained by photographing the placement location when the placement is detected.

### TECHNICAL FIELD

The present disclosure relates to a delivery management system and the like.

### BACKGROUND ART

In order to efficiently deliver a package, a service is provided in which a delivery staff places a delivery item at a placement location designated by a recipient. In such a service, since the delivery item is not directly delivered to the user, there is a need for the recipient to know whether the delivery has been delivered to the designated location. Therefore, an image of a location where the delivery staff has placed the delivery item is photographed and transmitted to the recipient or the like.

PTL 1 discloses a delivery receipt management system for a carrier to manage that a package has been delivered. A package delivery staff photographs a package receiving box on which a box ID is displayed. The photographed image is transmitted to a server by a communication terminal carried by the delivery staff.

PTL 2 discloses an article delivery confirmation system that uses position information at the time of reading an article identifier of a delivery article to confirm whether the delivery article has been normally delivered.

PTL 3 discloses a package delivery method in which a delivery staff photographs a state at the time of completion of delivery and transmits photographed data to a delivery company, and the delivery company determines the completion of delivery from the photographed data and notifies the delivery staff of the completion of delivery.

PTL 4 discloses a wearable device including a photographing device and a control unit that causes photographing to be started at a predetermined photographing start timing related to unlocking of a luggage room in order to improve security when delivering a package to the luggage room of a vehicle. The wearable device is carried by a user who delivers a package.

### CITATION LIST

### Patent Literature

### [PTL 1] JP 2019-058334 A

### [PTL 2] JP 2017-013923 A

### [PTL 3] JP 2006-225048 A

### [PTL 4] JP 2019-094167 A

### SUMMARY OF INVENTION

### Technical Problem

In PTLs 1 to 3, photographing an image and reading an identifier become troublesome for the delivery staff. Furthermore, in PTLs 1 to 3, an image that confirms the placement of the delivery item is not obtained.

In PTL 4, when a package is delivered to a luggage room of a vehicle, it is possible to acquire an image in which it can be determined that the package has been placed. However, when there is no locking/unlocking device disclosed in PTL 4, it is not possible to acquire an image that confirms the placement of the delivery item.

An object of the present disclosure is to provide a delivery management system, a verification acquisition method, and a program capable of generating an image that confirms the placement of a delivery item without bothering a delivery staff.

### Solution to Problem

A delivery management system according to the present disclosure includes: a detection means configured to detect placement of a delivery item at a placement location; and a generation means configured to generate a verification image obtained by photographing the placement location when the detection means detects the placement.

A delivery management method according to the present disclosure includes: detecting placement of a delivery item at a placement location; and generating a verification image obtained by photographing the placement location when the placement is detected.

A program according to the present disclosure causes a computer to execute: detecting placement of a delivery item at a placement location; and generating a verification image obtained by photographing the placement location when the placement is detected.

### Advantageous Effects of Invention

According to the present disclosure, it is possible to generate an image that confirms the placement of a delivery item without bothering a delivery staff.

### BRIEF DESCRIPTION OF DRAWINGS

FIG. 1 is a block diagram illustrating a configuration of a delivery management system 1 according to a first example embodiment.

FIG. 2 is a block diagram illustrating an example of a minimum configuration of the delivery management system 1.

FIG. 3 is a flowchart illustrating an operation of a delivery management device 100 according to the first example embodiment.

FIG. 4A is a diagram illustrating an example of a state when a detection unit 101 detects an action of placing a delivery item.

FIG. 4B is a diagram illustrating an example of a verification image according to the first example embodiment.

FIG. 5 is a block diagram illustrating a configuration of a delivery management system 1 according to a second example embodiment.

FIG. 6A is a diagram illustrating an example of a delivery list according to the second example embodiment.

FIG. 6B is a diagram illustrating an example of a verification image according to the second example embodiment.

FIG. 7 is a sequence diagram illustrating an operation of the delivery management system 1 according to the second example embodiment.

FIG. 8 is a block diagram illustrating a configuration of a delivery management device 100 according to a third example embodiment.

FIG. 9 is a flowchart illustrating an operation of the delivery management device 100 according to the third example embodiment.

FIG. 10 is a diagram illustrating an example of a delivery list according to the third example embodiment.

FIG. 11 is a diagram illustrating an example of a verification image according to the third example embodiment.

FIG. 12 is a diagram illustrating an example of a verification image according to the third example embodiment.

FIG. 13A is a diagram illustrating an example of a state when the detection unit 101 detects placement of a mail.

FIG. 13B is a diagram illustrating an example of a verification image according to Modification Example 1 of the third example embodiment.

FIG. 14A is a diagram illustrating an example of a delivery list according to Modification Example 2 of the third example embodiment.

FIG. 14B is a view illustrating a state in which the detection unit 101 detects the placement of a newspaper in a mail box.

FIG. 14C is a diagram illustrating an example of a verification image according to Modification Example 2 of the third example embodiment.

FIG. 15 is a block diagram illustrating an example of a hardware configuration of a computer 500.

### EXAMPLE EMBODIMENT

### First Example Embodiment

In the first example embodiment, a delivery staff delivering a delivery item places the delivered delivery item at a predetermined placement location. The placement location can be appropriately selected by the delivery staff or the user of the delivery service, such as by the front door, in the post, or in the package receiving box. Delivery items include packages, mails, newspapers, advertisements, and other items. The carrier requests the delivery staff to deliver items to the recipient and manages the delivery status.

### Configuration

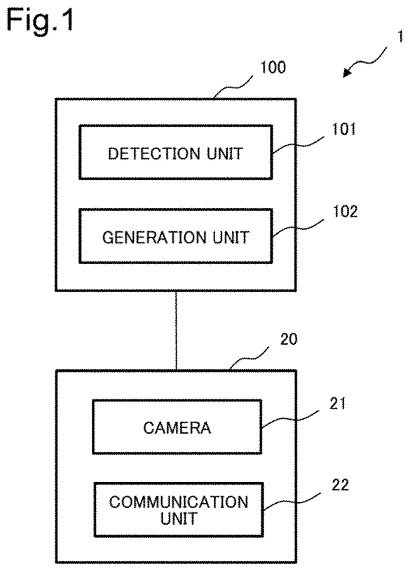

FIG. 1 is a block diagram illustrating a configuration of a delivery management system 1 according to the first example embodiment. The delivery management system 1 includes a delivery management device 100 and a wearable device 20.

The delivery management device 100 is communicably connected to a wearable device 20 worn by the delivery staff in a wired or wireless manner. The delivery management device 100 may be provided, for example, on a terminal carried by the delivery staff or on a server of a carrier that manages delivery by the delivery staff.

The wearable device 20 includes a camera 21 and a communication unit 22. The wearable device 20 is attached to any position of the delivery staff, such as the head, chest, shoulder, arm, or wrist. The camera 21 is provided at a position and in an orientation in which an image in which the placement location of the delivery item can be determined can be photographed. The camera 21 photographs an image using an imaging element such as a charge coupled device (CCD) image sensor or a complementary metal oxide semiconductor (CMOS) image sensor. The image obtained by photographing may be either a still image or a moving image. For example, the camera 21 may continue photographing while the delivery staff is working. The communication unit 22 transmits data of the image photographed by the camera 21 to the delivery management device 100.

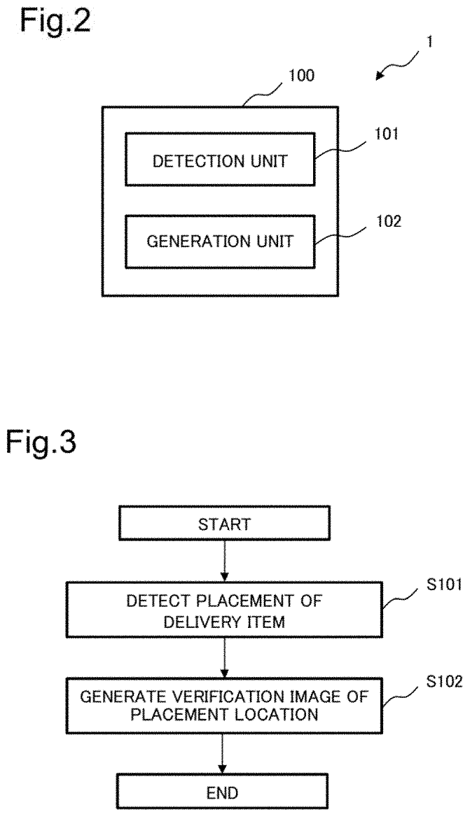

FIG. 2 is a block diagram illustrating an example of a minimum configuration of the delivery management system 1. The minimum configuration of the delivery management system 1 is the delivery management device 100.

The delivery management device 100 includes a detection unit 101 and a generation unit 102. The detection unit 101 detects the placement of the delivery item at the placement location. Detecting the placement of the delivery item at the placement location means, for example, detecting an action of placing the delivery item at the placement location, detecting a state in which the delivery item is placed at the placement location, or a state immediately before the delivery item is placed at the placement location. Alternatively, it may mean detecting an action before and after placing the delivery item. Hereinafter, an example of each detection will be described in detail.

1) Detecting action of placing delivery item

As an example of detecting the placement of the delivery item, a method in which the detection unit 101 detects an action of placing the delivery item at the placement location will be described.

Based on the image acquired from the camera 21, the detection unit 101 detects the action of the delivery staff at the time of placing the delivery item using a known image recognition technique or image analysis technique. For example, the detection unit 101 may detect any movement of the delivery staffs hand, arm, leg, or waist. The operation when placing the delivery item includes, for example, an operation in which the delivery staff puts the delivery item into a mail box, an operation in which the delivery staff puts the delivery item into a package receiving box, and an operation in which the delivery staff lowers the delivery item.

In addition, instead of detecting the action by the image recognition technique, the detection unit 101 may detect the action when placing the delivery item, based on a sensor value of, for example, an acceleration sensor, a gyro sensor, or a magnetic sensor that measures the action of the delivery staff. The sensors may be provided integrally with the wearable device 20 or may be attached to the delivery staffs body, gloves, or clothes separately from the wearable device 20.

2) Detecting state in which delivery item is placed

As an example of detecting the placement of the delivery item, a method in which the detection unit 101 detects a state in which the delivery item is placed will be described.

The detection unit 101 may detect the delivery staffs hand and the delivery item by a known image recognition technique or image analysis technique based on the image acquired from the camera 21, detect a state in which the delivery staffs hand has moved away from the delivery item, and detect a state in which the delivery item has been placed. Note that the detection unit 101 may detect a state in which the delivery staffs hand has moved away from the delivery item based on a measurement value from a contact sensor provided on a glove or the like of the delivery staff.

In addition, by providing a time of flight (TOF) sensor in the camera 21, the detection unit 101 may detect a surface of the delivery item and a placement surface of the delivery item such as a floor or a table from the acquired image, and may detect a state in which the delivery item is placed at a predetermined location. When the distance between the surface of the delivery item and the placement surface of the delivery item does not change for a predetermined time, the detection unit 101 may determine that the delivery item has been placed.

Furthermore, the detection unit 101 may detect a state in which the delivery item is placed by detecting that the delivery staff is away from the delivery item by a predetermined distance. The predetermined distance is appropriately set, for example, 50 cm or more from the delivery item. The distance between the delivery staff and the delivery item may be measured by an image recognition technique or an image analysis technique based on, for example, an image photographed by the camera 21 to determine that the size of the delivery item in the image decreases. In addition, a TOF sensor may be provided in the camera 21 to measure the distance from the delivery item to the camera 21. In addition, a radio frequency (RF) tag may be attached to the delivery item, and the delivery staff may carry a tag reader to measure that the delivery staff has left the delivery item. For example, the detection unit 101 may receive a notification that the delivery staff has moved a predetermined distance from the delivery item from the camera 21 or the tag reader described above.

3) Detecting state immediately before delivery item is placed

The detection unit 101 may detect the state immediately before the delivery item is placed instead of detecting the state in which the delivery item is placed. The detection unit 101 detects, as the state immediately before the delivery item is placed, for example, a state in which the delivery item is raised in front of the mail box, a state in which a part of the delivery item is put in the mail box, or a state in which the delivery item is carried into the box in a state in which the package receiving box is opened by the image recognition technique. 4) Detecting operation before and after placement of delivery item

The detection unit 101 may detect an action of placing the delivery item by detecting an action performed by the delivery staff before placing the delivery item. Furthermore, the detection unit 101 may detect the state in which the delivery item is placed by detecting an operation performed by the delivery staff after placing the delivery item. The operations before and after placement may be detected by adopting a method similar to the method for detecting the operation at the time of placement.

As the operation performed before placing, the detection unit 101 may detect an operation of twisting an arm, an operation of making it easy to put a delivery item into a mail box, and the like performed before the delivery staff puts the delivery item into the mail box. When the delivery item is a newspaper, the operation of easily putting the newspaper into the mail box includes, for example, an operation of folding the newspaper and an operation of flattening the newspaper by hitting the newspaper. In addition, as the operation after the placement, the detection unit 101 may detect an operation of pointing at the delivery item after the placement is completed.

Furthermore, the detection unit 101 may detect the action of placing the delivery item or the state in which the delivery item is placed by recognizing the voice of the delivery staff by the voice recognition technique. The detection unit 101 detects, for example, the action of placing the delivery item and the state in which the delivery item is placed by recognizing the voice of the delivery staff such as “Place it here.” or “Placement is completed.”

The operation of the delivery staff detected by the detection unit 101 may be set so that the above-described operation performed by the delivery staff can be generalized and detected as a basic operation and a derivative operation. Alternatively, the operation detected by the detection unit 101 may be set in advance for each delivery staff. By storing the operation for each delivery staff in advance, it is possible to accurately detect the operation.

The generation unit 102 generates a verification image of the placement location photographed when the detection unit 101 detects the placement of the delivery item. Specifically, the generation unit 102 acquires an image photographed by the camera 21. Furthermore, the generation unit 102 receives, from the detection unit 101, a notification indicating that the action of placing the delivery item is detected. For example, the generation unit 102 selects an image photographed when the detection unit 101 detects the placement of the delivery item from among the acquired images. For example, the image is selected based on the time when the image was photographed and the time when the placement of the delivery item was detected. The generation unit 102 generates a verification image based on the selected image. Note that the generation unit 102 may identify the delivery item from the acquired image and generate the verification image so that the delivery item is included.

### Operation

Next, an operation of the delivery management system 1 according to the first example embodiment will be described using the delivery management device 100 having a minimum configuration.

Hereinafter, an operation of the delivery management device 100 according to the first example embodiment will be described with reference to FIG. 3. FIG. 3 is a flowchart illustrating an operation of the delivery management device 100 according to the first example embodiment.

The delivery management device 100 is communicably connected to the wearable device 20 including the camera 21. The wearable device 20 is attached to, for example, the position of the delivery staffs chest, and the camera 21 is provided at a position and an orientation in which an image in which the placement location of the delivery item can be determined can be photographed. For example, the camera 21 starts photographing when the delivery staff leaves the delivery vehicle, and ends photographing when the delivery staff returns to the delivery vehicle. The wearable device 20 transmits data of an image photographed by the camera 21 to the delivery management device 100 via the communication unit 22.

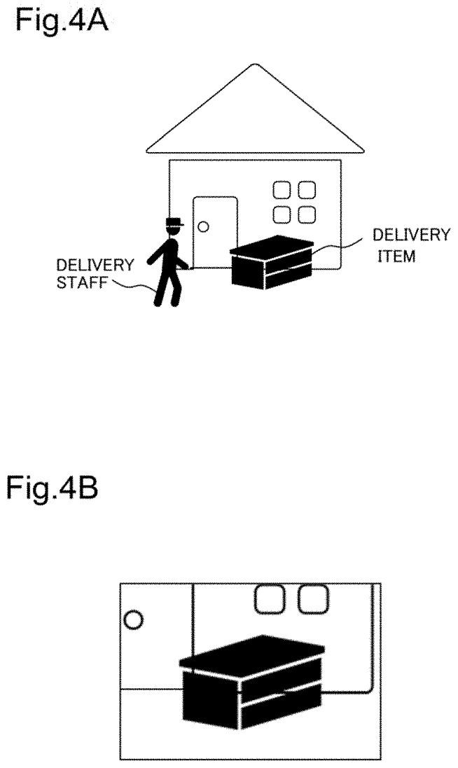

When the delivery staff brings the delivery item and delivers the delivery item to a predetermined destination, the detection unit 101 detects the placement of the delivery item at the placement location by the delivery staff (step S101). For example, the detection unit 101 detects an action of placing a delivery item. FIG. 4A is a diagram illustrating an example of the state of the entrance when the detection unit 101 detects the placement of the delivery item by the delivery staff. In FIG. 4A, the delivery staff has completed placement of the delivery item at the entrance.

The generation unit 102 generates a verification image of the placement location when the placement of the delivery item is detected (step S102). FIG. 4B is a diagram illustrating an example of the verification image generated from the image photographed in the state of FIG. 4A. The verification image illustrated in FIG. 4B includes the delivery item and the state around the delivery item.

### Effects

According to the first example embodiment, it is possible to acquire an image that confirms the placement of the delivery item without bothering the delivery staff. This is because the generation unit 102 generates the verification image obtained by photographing the placement location when the placement is detected.

Furthermore, according to the first example embodiment, even when the recipient does not prepare the receiving unit, an image that confirms the placement can be acquired. This is because the detection unit 101 detects the placement of the delivery item by the delivery staff, and the generation unit 102 generates a verification image obtained by photographing the placement location when the placement is detected.

### Modification Example

### Delivery by Robot

In the present disclosure, the delivery of the delivery item may be performed by a robot. In the present disclosure, the description of the delivery staff may be replaced with a robot as appropriate. The delivery robot includes an unmanned ground vehicle and an unmanned aerial vehicle (drone). In a variation, the delivery management device 100 may be mounted on a robot or may be included in a server of a carrier that manages the robot. For example, the delivery management device 100 is communicably connected to the camera 21 provided in the robot in a wired or wireless manner.

The robot acquires position information of the robot by a global positioning system (GPS) or the like. The robot may previously store the image of the road, the appearance of the building, the interior of the building, and the like in association with the map, and compare the stored image with the image photographed by the camera 21 to acquire the current position information. The position information may include information on the height. The robot carries the delivery item to the destination based on the destination's position information. When the robot arrives at the destination, the robot places the delivery item at a predetermined placement location. The placement location is, for example, in front of a front door.

If a flying drone delivers a delivery item, the drone may place the delivery item on the balcony of the building. At this time, the drone may measure the flight altitude. For example, the drone may calculate the flight altitude based on the first floor of the building by image recognition processing based on the image obtained by photographing the building. The drone may also measure the distance from the ground using a TOF sensor. A standard for measuring the height is appropriately set. Since the drone measures the height by a method other than the GPS, the drone can measure the height more accurately than a case where a method other than the GPS is not used. The drone can thus carry the delivery item to the correct height of the building.

As with the delivery by the delivery staff, the delivery management device 100 detects the placement of the delivery item by the robot. In addition, the delivery management device 100 generates a verification image of the placement location when the placement is detected.

The detection unit 101 may detect the placement of the delivery item by detecting a signal output by the robot when the delivery item is placed or when the placement is completed. Furthermore, the detection unit 101 may detect that the robot releases the arm holding the delivery item from the delivery item, and detect a state in which the delivery item is placed.

The detection unit 101 may detect a state in which the delivery item is placed by detecting that the robot is away from the delivery item by a predetermined distance. As a result, the generation unit 102 can generate the verification image of the placement location photographed after the robot is separated from the delivery item by the predetermined distance. Therefore, the generation unit 102 can generate the verification image including the delivery item and the situation around the delivery item. From the verification image including the surrounding situation, it may be possible to acquire information on the placement location to be described later in the description of the third example embodiment of the present disclosure. For example, the property of the recipient placed on the balcony serves as a mark of the placement location. For example, position information may be acquired from the verification image.

### Modification Example

### Imaging Around Placement Location

The camera 21 may have a wide angle of view, such as a 360-degree camera. The camera 21 may photograph an appearance of a building including a placement location and its periphery. The generation unit 102 may generate an image including the appearance of the building as the verification image. This allows the recipient (or the carrier, or the like) to confirm that the delivery item was placed in the correct location based on the relative position of the building appearance and placement location. For example, the camera 21 may photograph an entire side surface of a building.

The generation unit 102 may generate the verification image in which the placement location is mapped by coloring the placement location in the verification image or indicating the placement location with an arrow. The generation unit 102 may generate a verification image obtained by performing mosaic processing on the appearance of a building other than the placement location. As a result, for example, when the camera 21 photographs an image including the appearance of a neighboring house, it is possible to generate a verification image in consideration of privacy.

### Second Example Embodiment

### Configuration

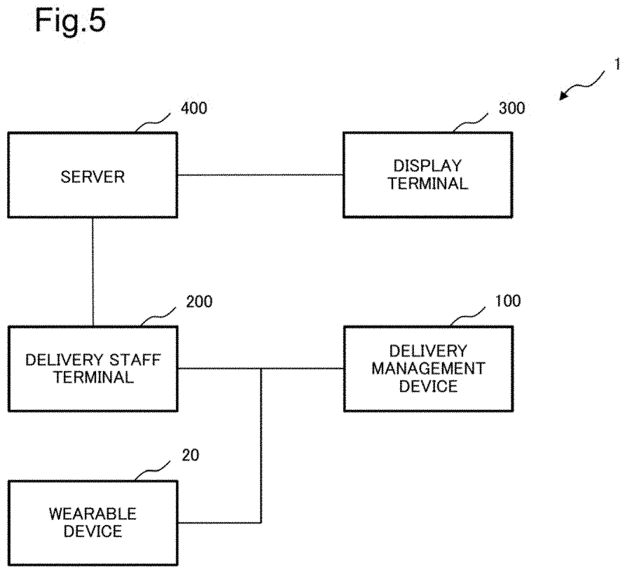

A delivery management system 1 according to a second example embodiment will be described. FIG. 5 is a block diagram illustrating a configuration of a delivery management system 1 according to the second example embodiment. The delivery management system 1 includes the delivery management device 100 and the wearable device 20 according to the first example embodiment, a delivery staff terminal 200, a display terminal 300, and a server 400.

In the delivery management system 1 of the second example embodiment, the wearable device 20, the delivery management device 100, and the delivery staff terminal 200 are communicably connected. In addition, the delivery staff terminal 200 is communicably connected to the server 400, and the server 400 is communicably connected to the display terminal 300.

Hereinafter, the configuration of the delivery management system 1 according to the second example embodiment will be described in detail, but the description of the same configuration as that of the first example embodiment may be omitted for the delivery management device 100 and the wearable device 20.

The delivery staff terminal 200 is a terminal carried by a delivery staff. The delivery staff terminal 200 may be, for example, a small computer such as a smartphone, a mobile phone, a tablet terminal, or a wearable computer (such as a smart watch), or may be a personal computer.

The wearable device 20 and the delivery staff terminal 200 may be integrated or provided separately. The image photographed by the camera 21 may be sent to the delivery management device 100 or the delivery staff terminal 200 via the communication unit 22.

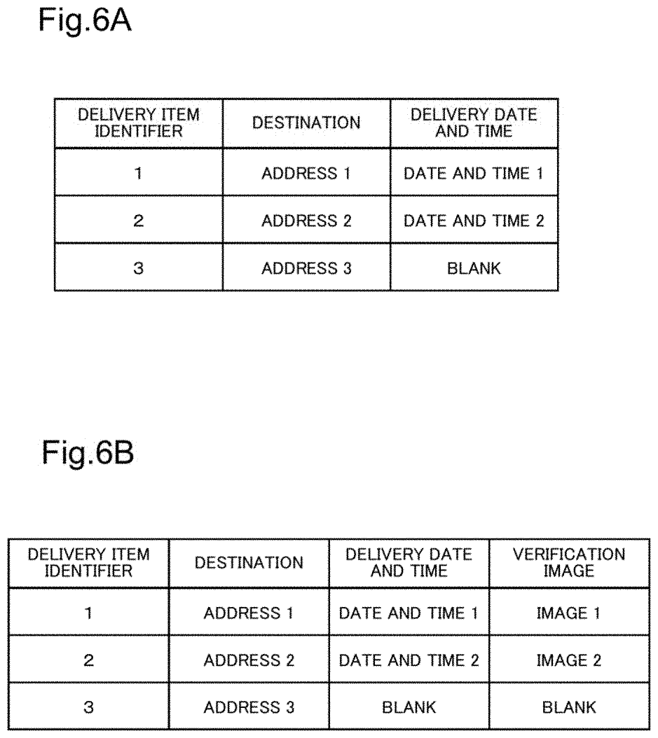

The delivery staff terminal 200 may receive the delivery list from the server 400 and store the delivery list. The delivery list is, for example, a list including information for identifying a delivery item that the delivery staff is responsible for and information on a destination of the delivery item. The information for identifying the delivery item may be a delivery item identifier represented by numbers or letters. The information on the destination may include an address, a name, or a telephone number of the recipient. The delivery list may include information about the items. FIG. 6A is a diagram illustrating an example of a delivery list. The delivery staff delivers the delivery item based on the delivery list.

The delivery management device 100 may transmit the generated verification image to the delivery staff terminal 200. The delivery staff terminal 200 may receive the verification image and transmit the received verification image to the server 400.

The server 400 may generate a delivery list and output the generated delivery list to the delivery staff terminal 200 carried by each delivery staff. The server 400 receives and stores the verification image. Furthermore, the server 400 outputs the verification image of the placement location to the display terminal 300.

The display terminal 300 is used by any one of the carrier, the delivery staff, the sender, and the recipient to confirm the verification image. The display terminal 300 is, for example, a display of a smartphone, a personal computer, or an intercom with a display.

The display terminal 300 requests the server to output the verification image. Furthermore, the display terminal 300 receives and displays the verification image that has been requested and output. The carrier's display terminal 300 can request verification images of all delivery staffs. The delivery staffs display terminal 300 requests a verification image for the delivery item the delivery staff is responsible for. The display terminals 300 of the sender and the recipient request a verification image for the delivery item they send or receive.

### Operation

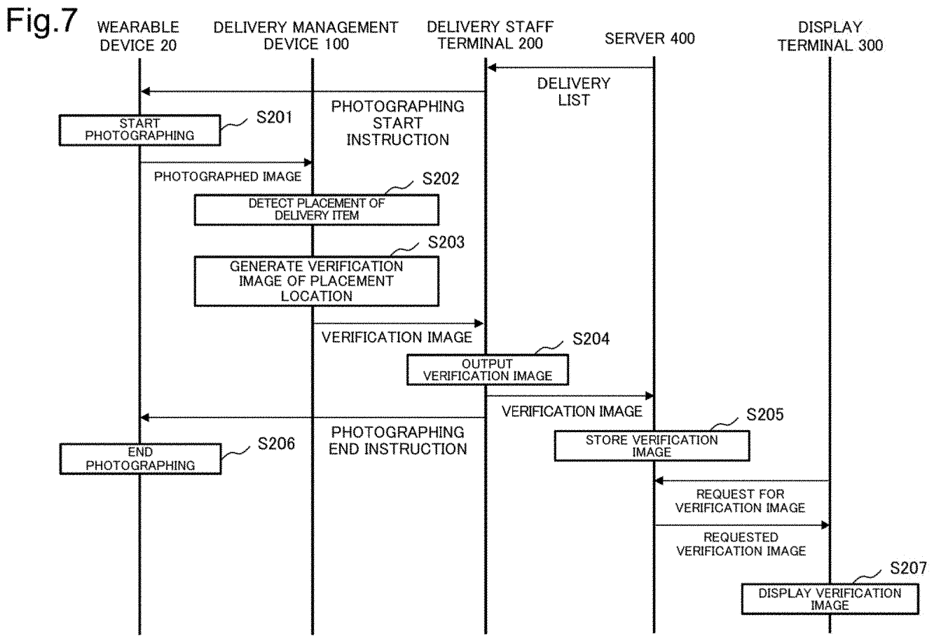

Hereinafter, an operation of the delivery management system 1 according to the second example embodiment will be described with reference to FIG. 7. FIG. 7 is a sequence diagram illustrating an operation of the delivery management system 1 according to the second example embodiment.

The delivery staff terminal 200 receives the delivery list from the server 400. The delivery staff moves one after another to the addresses listed in the delivery list indicated by the delivery staff terminal 200. When the delivery staff terminal 200 detects that the delivery staff has approached the address on the delivery list, the delivery management system 1 starts image acquisition processing. The approach to the address is detected using position information such as GPS and a map. The delivery staff terminal 200 instructs the wearable device 20 to start photographing, and the wearable device 20 starts photographing (step S201). The wearable device 20 transmits the photographed image to the delivery management device 100. When the image to be transmitted is a still image, the wearable device 20 repeats photographing and transmission of the still image at predetermined time intervals until a photographing end instruction is received from the delivery staff terminal 200. The time interval is arbitrary, but is preferably 10 seconds or less. When the image to be transmitted is a moving image, the wearable device 20 continues to photograph and transmit the moving image until a photographing end instruction is received from the delivery staff terminal 200.

The detection unit 101 of the delivery management device 100 detects the placement of the delivery item (step S202). Next, the generation unit 102 of the delivery management device 100 generates a verification image of the placement location when the detection unit 101 detects the placement (step S203). The delivery management device 100 transmits the generated verification image to the delivery staff terminal 200.

The delivery staff terminal 200 outputs the verification image to the server 400 (step S204). The server 400 stores the received verification image (step S205).

When detecting that the delivery staff has moved from the address listed in the delivery list, the delivery staff terminal 200 instructs the wearable device 20 to end photographing, and the wearable device 20 ends photographing (step S206). Note that the delivery staff may register information indicating delivery completion in the delivery staff terminal 200, thereby transmitting an instruction to end photographing to the wearable device 20. Thus, the image acquisition process ends.

Next, when the display terminal 300 sends a request for a verification image to the server 400, the delivery management system 1 starts image display processing. In response to the request, the server 400 transmits the requested verification image to the display terminal 300. The display terminal 300 displays the received verification image (step S207). Thus, the image display processing ends.

### Effects

According to the second example embodiment, it is possible to confirm an image that confirms the placement of the delivery item. This is because the server 400 outputs the verification image generated by the delivery management device 100 to the display terminal 300.

When the delivery list including the verification image is output to the display terminal 300 used by the delivery staff, the delivery staff can confirm at a glance whether the delivery staff has placed the delivery item, based on the presence or absence of the verification image. When the verification image is output to the display terminal 300 used by the carrier, the manager of the carrier can determine whether the delivery staff has delivered the package and whether the delivery staff has placed the package in accordance with rules set in business. When the verification image is output to the display terminal 300 used by the sender, the sender can confirm that the delivery item has been placed without being lost on the way. When the verification image is output to the display terminal 300 used by the recipient, the recipient can confirm that the delivery item is placed at the correct destination.

### Modification Example

Although the case where the delivery staff terminal 200 transmits the verification image to the server 400 has been described in the second example embodiment, the delivery management device 100 may transmit the verification image to the server 400 without using the delivery staff terminal 200.

The delivery staff terminal 200 or the server 400 may receive a notification of detection of the placement from the detection unit 101, and further transmit a notification regarding the placement to the portable terminal of the recipient or an intercom provided

The delivery staff terminal 200 may acquire the position information of the delivery staff by GPS or the like. When the delivery staff terminal 200 detects that the delivery staff has approached the address described in the delivery list based on the acquired position information, the delivery staff terminal 200 may activate the camera 21 and perform control to start photographing. The delivery staff terminal 200 may transmit the image photographed by the camera 21 to the server 400. As a result, the states before and after the placement of the delivery item can be transmitted to the server 400. The delivery staff terminal 200 may reduce the resolution of an image obtained by photographing an area other than the placement location and transmit the image to the server 400. As a result, the communication amount can be reduced, and privacy can be considered.

Furthermore, the delivery staff terminal 200 may transmit the position information acquired when the placement is detected to the server 400. The server 400 stores the acquired position information and the verification image in association with each other.

The delivery list may include information on necessity of acquisition of the verification image. Depending on the sender or the recipient, some people do not wish to photograph the placement location. In addition, when the recipient directly receives the delivery item, or when the recipient places the delivery item in the presence of the recipient, verification of placement is unnecessary. Therefore, the delivery staff terminal 200 may determine the necessity of the verification image based on the delivery list. The delivery staff terminal 200 may control the camera 21 not to be activated when it is determined that the verification image is unnecessary.

When receiving the verification image, the server 400 may update the delivery list so that the verification image is included. FIG. 6B is a diagram illustrating an example of a delivery list including a verification image. For example, when the updated delivery list of FIG. 6B is output to the display terminal 300 of the carrier, the carrier can easily confirm the verification image.

### Third Example Embodiment

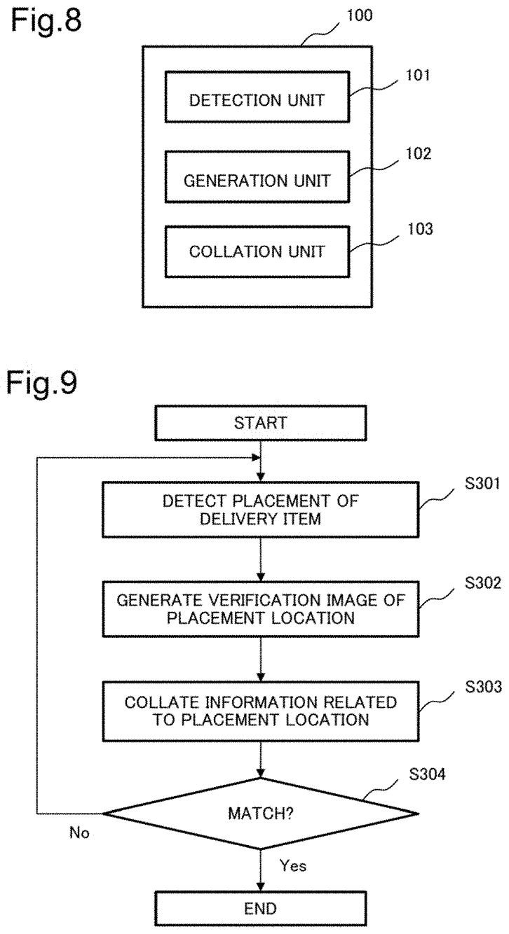

A delivery management device 100 according to a third example embodiment will be described. The delivery management device 100 according to the third example embodiment further includes a collation unit 103 in order for the delivery management device 100 of the delivery management system 1 according to the first and second example embodiments to confirm the placement location. FIG. 8 is a block diagram illustrating a configuration of the delivery management device 100 according to the third example embodiment. Note that the collation unit 103 according to the third example embodiment may be included in the delivery staff terminal 200 or the server 400.

In the following description, description of configurations similar to those of the first example embodiment or the second example embodiment may be omitted.

In the third example embodiment, the generation unit 102 generates a verification image indicating information on the placement location. The information on the placement location is information on a mark of the placement location. The information on the placement location includes information for specifying the placement location. The position information is included in the information for specifying the placement location. When the information is placed at the entrance, the information on the placement location includes a name or a room number posted on a doorplate or a door of the entrance, and a decoration placed at the entrance. In addition, when a delivery item is placed in a mail box, the information on the placement location includes a name or a room number displayed on the mail box.

The generation unit 102 may recognize the delivery item from the image acquired from the camera 21. At this time, the generation unit 102 may generate a verification image showing both the delivery item and the information on the placement location.

The collation unit 103 collates the information on the placement location indicated by the verification image with the information included in the delivery list to confirm the placement location. When the information indicated by the verification image matches the information included in the delivery list, the delivery management device 100 may transmit to the server 400 that the placement has been completed.

The collation unit 103 may output the collation result to the delivery staff terminal 200. The delivery staff terminal 200 may display the collation result. As a result, it is possible to notify the delivery staff whether the placement location is correct. Also, if the placement location is incorrect, the delivery staff can place the delivery item again. Sending the collation result to the server 400 enables the server 400 or the carrier to instruct the delivery staff to place the delivery item again if the placement location is incorrect.

In one example, the generation unit 102 recognizes a doorplate as information on a placement location from an image photographed when placement of a delivery item is detected by an image recognition technique. The generation unit 102 generates a verification image so that the recognized doorplate is included. The collation unit 103 may acquire the verification image from the generation unit 102, and recognize the name displayed on the doorplate by image recognition processing. The collation unit 103 collates the name indicated by the verification image with the name included in the delivery list.

In another example, the collation unit 103 may acquire a verification image obtained by photographing the mail box, and recognize the room number displayed in the mail box by image recognition processing. The collation unit 103 may collate the room number indicated by the verification image with the room number of the address included in the delivery list.

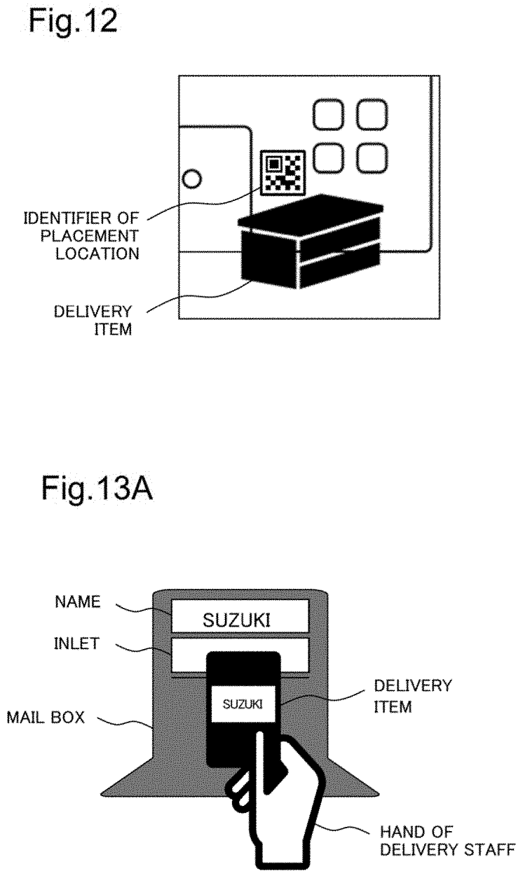

In another example, the collation unit 103 may perform collation using a label, on which an identifier of a placement location is printed, affixed near the placement location as information on a mark of the placement location. The identifier of the placement location is a character string, a code obtained by encoding the character string, or the like. The label is attached to a doorplate, a mail box, a package receiving box, a front door, a wall of the entrance, and the like. FIG. 12 is a diagram illustrating an example of a verification image including an identifier of a placement location and a delivery item placed near the identifier. The collation unit 103 may collate the identifier of the placement location included in the delivery list with the identifier indicated by the verification image. When placing a delivery item in front of a water, gas, or electricity meter, an identifier attached to the meter may be used as the identifier of the placement location.

The collation unit 103 may further collate the position information acquired by the delivery staff terminal 200 or the robot when the placement is detected with the position information of the destination included in the delivery list.

Note that the information on the placement location may be stored in the server 400 in advance in association with the destination. The collation unit 103 may refer to the information on the placement location stored in the server 400 and collate the information on the placement location indicated by the verification image. Note that the information on the placement location may be stored in the delivery staff terminal 200 before placement. If the information on the placement location is displayed on the delivery staff terminal 200, the delivery staff can know in advance where to place the delivery item.

### Operation

Hereinafter, an operation of the delivery management device 100 according to the third example embodiment will be described with reference to FIG. 9. FIG. 9 is a flowchart illustrating an operation of the delivery management device 100 according to the third example embodiment.

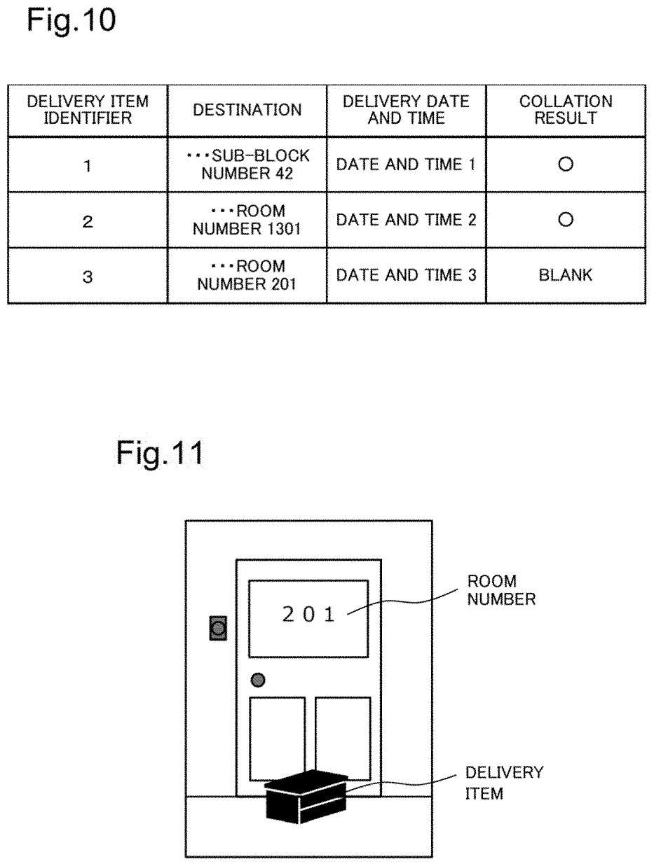

FIG. 10 is a diagram illustrating an example of a delivery list according to the third example embodiment. The delivery management device 100 obtains the identifier of the delivery item that the delivery staff intends to deliver from the delivery list. The delivery staff terminal 200 may receive a selection of a delivery item to be delivered by the delivery staff and notify the delivery management device 100 of the selected identifier. In addition, the delivery staff terminal 200 may read the delivery item identifier attached to the delivery item and notify the detection unit 101 of the read identifier. The delivery staff terminal 200 may determine a delivery item to be delivered by the delivery staff based on the position information of the delivery staff.

In the following example, a case where the delivery staff places a delivery item associated with the delivery item identifier “3” will be described. The detection unit 101 detects an action of the delivery staff placing the delivery item at the placement location (step S301).

The generation unit 102 generates the verification image of the placement location when the placement of the delivery item is detected so that information on the placement location is included (step S302). FIG. 11 is a diagram illustrating an example of a verification image to be generated.

The collation unit 103 acquires information on the placement location indicated by the verification image. For example, the collation unit 103 acquires the room number “201” posted on the door from the verification image in FIG. 11 using the image recognition technique. Furthermore, the collation unit 103 acquires information on the placement location included in the delivery list based on the identifier of the delivery item acquired from the delivery staff terminal 200. For example, the collation unit 103 acquires that the destination of the delivery item with the delivery item identifier “3” is the room number 201 from the delivery list in FIG. 10. Next, the collation unit 103 collates the room number indicated by the verification image with the room number of the destination included in the delivery list (step S303). When the information on the placement location indicated by the verification image matches the information included in the delivery list (step S304: Yes), the delivery management device 100 terminates the operation.

When the information in the verification image and the information in the delivery list do not match and the delivery staff places the delivery item again (step S304: No), the delivery management device 100 executes steps S301 to S303 again.

### Effects

According to the third example embodiment, it is possible to confirm whether the delivery item is placed at the wrong address by collating the information on the destination included in the delivery list with the information on the placement location indicated by the verification image.

### Modification Example 1

### Collation of Destination Attached to Delivery Item and Placement Location

In the third example embodiment, the case where the collation unit 103 collates the information indicated by the verification image with the information included in the delivery list has been described. However, in Modification Example 1, the collation unit 103 may collate the information on the destination attached to the delivery item indicated by the verification image with the information on the placement location indicated by the verification image. The information on the destination includes an address, a recipient, or encoded versions thereof.

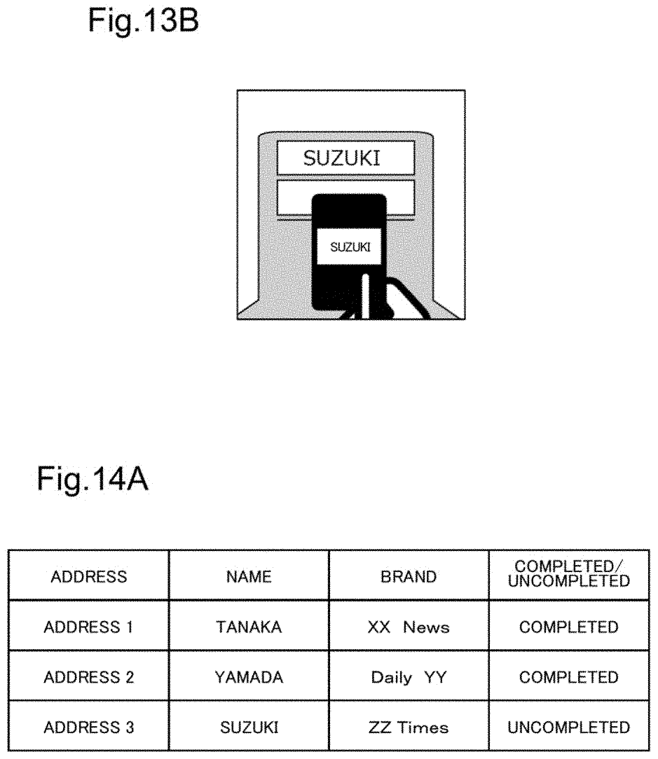

As illustrated in FIG. 13A, a case where the delivery staff places a mail in the mail box will be described as an example. When the action of placing the delivery item by the delivery staff is detected, the generation unit 102 generates a verification image illustrated in FIG. 13B. In this case, the generation unit 102 recognizes the information indicating the destination attached to the delivery item, and generates the verification image indicating the information on the destination.

The collation unit 103 acquires the name “SUZUKI” displayed in the mail box as the information on the placement location by the image recognition processing based on the verification image. Furthermore, the collation unit 103 acquires the address “SUZUKI” described in the mail as the information on the destination by the image recognition processing based on the verification image. Next, the collation unit 103 collates the acquired name of the mail box with the name of the mail.

According to Modification Example 1, it is possible to confirm that the delivery item is delivered to the destination attached to the delivery item by collation between the information on the destination indicated by the verification image and the information on the placement location.

### Modification Example 2

### Collation of Brand of Delivery Item and Placement Location

In Modification Example 2, the collation unit 103 may collate the information on the brand of the delivery item indicated by the verification image with the information on the brand included in the delivery list. The delivery management system 1 according to Modification Example 2 can be applied to a case where the delivery staff distinguishes brands of delivery items with no destination such as newspapers and dairy products and delivers the delivery items to a plurality of destinations.

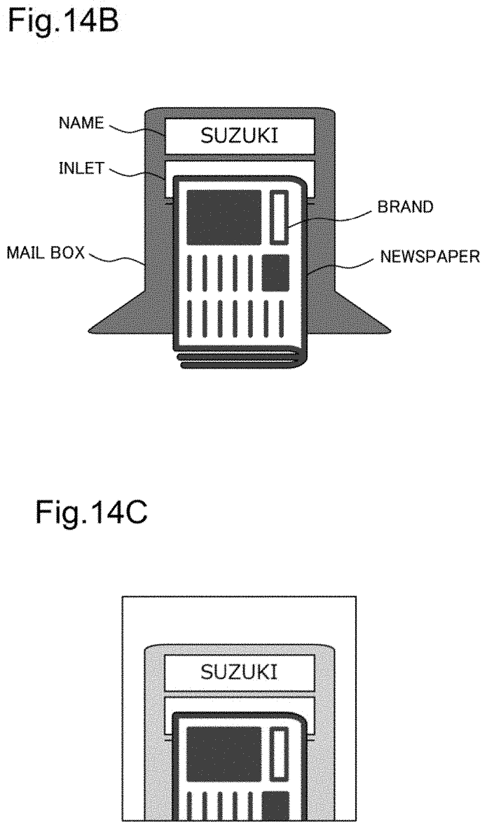

Hereinafter, a case where a newspaper delivery staff delivers newspapers from a plurality of companies to each destination according to the delivery list will be described as an example. FIG. 14A is a diagram illustrating an example of a delivery list according to Modification Example 2. The delivery list includes the recipient's address, the recipient's name, the brand of the delivery item, and whether the delivery has been completed. FIG. 14B is a diagram illustrating a state in which the detection unit 101 detects the placement of the newspaper in the mail box. For example, a name is displayed in a mail box, and information indicating a brand is displayed in a newspaper.

FIG. 14C is a diagram illustrating an example of the verification image according to Modification Example 2. The collation unit 103 collates the name indicated by the verification image, which is information on the destination, with the name included in the delivery list. Furthermore, the collation unit 103 collates the brand included in the delivery list with the brand of the delivery item indicated by the verification image. The collation unit 103 transmits the collation result to the delivery staff terminal 200 or the server 400.

According to Modification Example 2, it is possible to confirm whether the product of the correct brand has been placed at the placement location by collating the information on the brand of the delivery item indicated by the verification image with the information on the brand included in the delivery list.

The delivery list may further include the number of delivery items to be placed at the placement location. The collation unit 103 may collate the number of delivery items recognized from the verification image with the number of delivery items included in the delivery list. When the delivery item is a newspaper, the collation unit 103 may recognize the number of copies of the newspaper based on the thickness of the newspaper in the verification image.

The delivery staff may make a mistake in the number of delivery items to be placed, place a delivery item of a different brand, or make a placement error. Therefore, a collection station for storing undelivered or extra delivery items may be provided. The collection site is, for example, a convenience store. The recipient causes the display terminal 300 used by the recipient to display a verification image at the collection station, indicating that there is a placement error, and receives the delivery item at the collection station. The display terminal 300 may display the collation result from the collation unit 103 instead of displaying the verification image to indicate that there is a placement error. With the collection station, the delivery staff does not need to deliver the delivery item again.

### Hardware Configuration

In each of the above-described example embodiments, each component of the delivery management device 100 indicates a block of functional units. Some or all of the components of each device including the delivery management device 100, the delivery staff terminal 200, the display terminal 300, and the server 400 may be realized by an arbitrary combination of a computer 500 and a program.

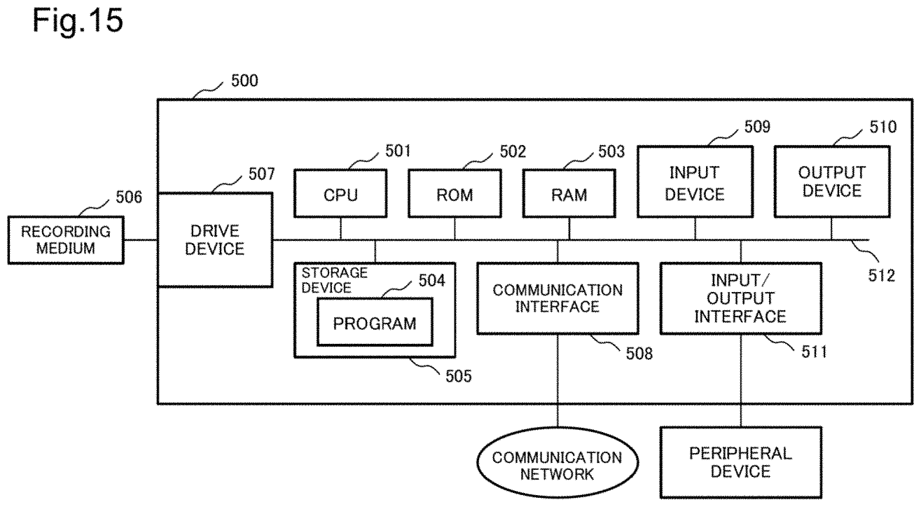

FIG. 15 is a block diagram illustrating an example of a hardware configuration of the computer 500. Referring to FIG. 15, the computer 500 includes, for example, a central processing unit (CPU) 501, a read only memory (ROM) 502, a random access memory (RAM) 503, a program 504, a storage device 505, a drive device 507, a communication interface 508, an input device 509, an input/output interface 511, and a bus 512.

The program 504 includes an instruction for realizing each function of each device. The program 504 is stored in advance in the ROM 502, the RAM 503, and the storage device 505. The CPU 501 realizes each function of each device by executing instructions included in the program 504. For example, the CPU 501 of the delivery management device 100 executes an instruction included in the program 504 to implement the function of the delivery management device 100. Furthermore, the RAM 503 may store data to be processed in each function of each device. For example, the verification image in the delivery management device 100 may be stored in the RAM 503 of the computer 500.

The drive device 507 reads and writes data from and to the recording medium 506. The communication interface 508 provides an interface with a communication network. The input device 509 is, for example, a mouse, a keyboard, or the like, and receives an input of information from a carrier, a recipient, or the like. The output device 510 is, for example, a display, and outputs (displays) information to a carrier, a recipient, or the like. The input/output interface 511 provides an interface with a peripheral device. The bus 512 connects the respective components of the hardware. Note that the program 504 may be supplied to the CPU 501 via a communication network, or may be stored in the recording medium 506 in advance, read by the drive device 507, and supplied to the CPU 501.

Note that the hardware configuration illustrated in FIG. 15 is an example, and other components may be added or some components may not be included.

There are various modification examples of the implementation method of each device. For example, each device may be realized by an arbitrary combination of a computer and a program different for each component. In addition, a plurality of components included in each device may be realized by an arbitrary combination of one computer and a program.

In addition, some or all of the components of each device may be realized by general-purpose or dedicated circuitry including a processor or the like, or a combination thereof. These circuits may be configured by a single chip or may be configured by a plurality of chips connected via a bus. Some or all of the components of each device may be realized by a combination of the above-described circuit or the like and a program.

In addition, when some or all of the components of each device are realized by a plurality of computers, circuits, and the like, the plurality of computers, circuits, and the like may be arranged in a centralized manner or in a distributed manner.

In addition, at least a part of the delivery management system 1 may be provided in a software as a service (SaaS) format. That is, at least a part of the functions for implementing the delivery management device 100 may be executed by software executed via a network.

Although the present disclosure has been described with reference to the exemplary example embodiments, the present disclosure is not limited to the exemplary example embodiments. Various modification examples that can be understood by those skilled in the art can be made to the configuration and details of the present disclosure within the scope of the present disclosure. In addition, the configurations in the respective example embodiments can be combined with each other without departing from the scope of the present disclosure.

Some or all of the above example embodiments may be described as the following supplementary notes, but are not limited to the following.

### Supplementary Note 1

A delivery management system comprising:

a detection means configured to detect placement of a delivery item at a placement location; and

a generation means configured to generate a verification image obtained by photographing the placement location when the detection means detects the placement.

### Supplementary Note 2

The delivery management system according to supplementary note 1, wherein

the detection means detects the placement by detecting an action of placing the delivery item at the placement location.

### Supplementary Note 3

The delivery management system according to supplementary note 2, wherein

the detection means detects the action based on an image obtained by photographing an operation of a delivery staff or a sensor value obtained by measuring an operation of the delivery staff.

### Supplementary Note 4

The delivery management system according to any one of supplementary notes 1 to 3, wherein

the detection means detects the placement by detecting a state in which the delivery item is placed.

### Supplementary Note 5

The delivery management system according to supplementary note 4, wherein

the detection means detects the placed state based on an image obtained by photographing an operation of the delivery staff or a sensor value obtained by measuring an operation of the delivery staff.

### Supplementary Note 6

The delivery management system according to any one of supplementary notes 1 to 5, wherein

the detection means detects the placement by detecting a state immediately before the placement.

### Supplementary Note 7

The delivery management system according to supplementary note 6, wherein

the detection means detects the state immediately before the placement based on an image obtained by photographing an operation of the delivery staff or a sensor value obtained by measuring an operation of the delivery staff.

### Supplementary Note 8

The delivery management system according to any one of supplementary notes 1 to 7, wherein

the detection means detects the placement of the delivery item based on a delivery staff or a robot moving away from the delivery item.

### Supplementary Note 9

The delivery management system according to any one of supplementary notes 1 to 8, wherein

the generation means generates the verification image indicating information on the placement location.

### Supplementary Note 10

The delivery management system according to supplementary note 9, wherein

the information on the placement location indicated by the verification image is any one of information on a doorplate, information on a mail box, an identifier of the placement location, and position information.

### Supplementary Note 11

The delivery management system according to supplementary note 9 or 10, further comprising:

a collation means configured to collate information on a destination included in a delivery list with information on the placement location indicated by the verification image.

### Supplementary Note 12

The delivery management system according to supplementary note 9 or 10, further comprising:

a collation means configured to collate information on a destination indicated by the verification image with information on the placement location.

### Supplementary Note 13

A delivery management method comprising:

detecting placement of a delivery item at a placement location; and

generating a verification image obtained by photographing the placement location when the placement is detected.

### Supplementary Note 14

A non-transitory recording medium having a program recorded therein, the program causing a computer to execute:

detecting placement of a delivery item at a placement location; and

generating a verification image obtained by photographing the placement location when the placement is detected.

This application is based upon and claims the benefit of priority from Japanese patent application No. 2020-118333, filed on Jul. 9, 2020, the disclosure of which is incorporated herein in its entirety by reference.

### REFERENCE SIGNS LIST

1 Delivery management system
100 Delivery management device
101 Detection unit
102 Generation unit
103 Collation unit
20 Wearable device
200 Delivery staff terminal
300 Display terminal
400 Server
500 Computer

What is claimed is:

1. A delivery management system comprising:
at least one memory configured to store instructions; and
at least one processor configured to execute the instructions to:
detect placement of a delivery item at a placement location; and
generate a verification image obtained by photographing the placement location when the placement is detected.

2. The delivery management system according to claim 1, wherein the at least one processor is configured to execute the instructions to:
detect the placement by detecting at least one of:
an action of placing the delivery item at the placement location,
a state in which the delivery item is placed, and
a state immediately before the delivery item is placed.

3. The delivery management system according to claim 2, wherein the at least one processor is configured to execute the instructions to:
detect the action, the placed state, or the state immediately before the placement based on at least one of:
an image obtained by photographing an operation of a delivery staff; and
a sensor value obtained by measuring an operation of the delivery staff.

4. The delivery management system according to claim 1, wherein the at least one processor is further configured to execute the instructions to:
detect the placement by detecting a state in which the delivery item is placed.

5. The delivery management system according to claim 4, wherein the at least one processor is further configured to execute the instructions to:
detect the placed state based on at least one of:
an image obtained by photographing an operation of the delivery staff; and
a sensor value obtained by measuring an operation of the delivery staff.

6. The delivery management system according to claim 1, wherein the at least one processor is further configured to execute the instructions to:
detect the placement by detecting a state immediately before the placement.

7. The delivery management system according to claim 6, wherein the at least one processor is further configured to execute the instructions to:
detect the state immediately before the placement based on at least one of:
an image obtained by photographing an operation of the delivery staff; and
a sensor value obtained by measuring an operation of the delivery staff.

8. The delivery management system according to claim 1, wherein the at least one processor is configured to execute the instructions to:
detect the placement based on detection of a delivery staff or a robot moving away from the delivery item.

9. The delivery management system according to claim 1, wherein the at least one processor is configured to execute the instructions to:
generate the verification image indicating information on the placement location.

10. The delivery management system according to claim 9, wherein
the information on the placement location indicated by the verification image is any one of information on a doorplate, information on a mail box, an identifier of the placement location, and position information.

11. The delivery management system according to claim 9, wherein the at least one processor is further configured to execute the instructions to:
collate information on a destination included in a delivery list with information on the placement location indicated by the verification image.

12. The delivery management system according to claim 9, wherein the at least one processor is further configured to execute the instructions to:
collate information on a destination indicated by the verification image with information on the placement location.

13. A delivery management method comprising:
detecting placement of a delivery item at a placement location; and
generating a verification image obtained by photographing the placement location when the placement is detected.

14. A non-transitory recording medium having a program recorded therein, the program causing a computer to execute:
detecting placement of a delivery item at a placement location; and
generating a verification image obtained by photographing the placement location when the placement is detected.

15. The delivery management system according to claim 1, wherein the at least one processor is configured to execute the instructions to:
detect the placement by detecting an action of placing the delivery item at the placement location.

16. The delivery management system according to claim 15, wherein the at least one processor is configured to:
execute the instructions to detect the action based on at least one of:
an image obtained by photographing an operation of a delivery staff; and
a sensor value obtained by measuring an operation of the delivery staff.

17. The delivery management system according to claim 1, wherein the at least one processor is configured to execute the instructions to:
detect the placement based on at least one of:
an image obtained by photographing an operation of a delivery staff; and
a sensor value obtained by measuring an operation of the delivery staff.

18. The delivery management system according to claim 1, wherein the at least one processor is configured to execute the instructions to:
detect the placement performed by a delivery robot.

19. The delivery management system according to claim 1, further comprising:
a delivery robot that delivers the delivery item,
wherein the at least one memory and the at least one processor are mounted on the delivery robot.
